(19) United States
(12) Patent Application Publication
(10) Pub. No.: US 2013/0201296 A1
(43) Pub. Date: Aug. 8, 2013

(54) MULTI-CAMERA HEAD

(71) Applicants: Mitchell Weiss, Carlisle, MA (US); Hans Moravec, Pittsburgh, PA (US)

(72) Inventors: Mitchell Weiss, Carlisle, MA (US); Hans Moravec, Pittsburgh, PA (US)

(21) Appl. No.: 13/836,619

(22) Filed: Mar. 15, 2013

Related U.S. Application Data
(63) Continuation-in-part of application No. 29/398,127, filed on Jul. 26, 2011, now Pat. No. D680142.
Application No. 29/398,127 is a continuation-in-part of application No. 13/731,897, filed on Dec. 31, 2012.
(60) Provisional application No. 61/581,863, filed on Dec. 30, 2011.

(51) Int. Cl. H04N 13/02

(52) U.S. Cl. CPC H04N 13/0242
USPC 348/48

(57) ABSTRACT

A multi-camera head includes a plurality of stereo cameras mounted together and having their fields of view projecting in different directions, where the fields of view may or may not overlap. The cameras can be mounted to different sides of a frame and can be used in mobile contexts for mapping, navigation, or both, as examples. One or more of the cameras can be pitched at an angle, and a method may be provided for graphically viewing and analyzing field of view projections of the cameras considering the pitch angle.

### CROSS REFERENCE TO RELATED APPLICATIONS

This is a continuation-in-part application that claims the benefit of priority under 35 U.S.C. §120 from United States Design Application serial number 29/398,127, entitled MULTI-CAMERA HEAD, filed on Jul. 26, 2011, which is incorporated herein by reference in its entirety.

This is a continuation-in-part application that claims the benefit of priority under 35 U.S.C. §120 from U.S. patent application Ser. No. 13/731,897, filed Dec. 31, 2012, entitled AUTO-NAVIGATING VEHICLE WITH FIELD-OF-VIEW ENHANCING SENSOR POSITIONING AND METHOD OF ACCOMPLISHING SAME, which claimed priority from U.S. Provisional Application 61/581,863, filed Dec. 30, 2011, entitled ROBOTIC VEHICLE WITH OPERATOR FIELD OF VIEW ENHANCING SENSOR POSITIONING AND METHOD OF ACCOMPLISHING SAME, which are incorporated herein by reference in their entireties.

### FIELD OF INTEREST

The present inventive concepts relate to the field of stereo sensors, and more particularly to the field of camera heads using such stereo cameras.

### BACKGROUND

A stereo sensor, at a high level, is a sensor that forms a single product, result, or output from inputs simultaneously from a pair of sensors or detectors. For example, a stereo camera is a pair of cameras that generate a single view of an imaged entity or location from image information received from both cameras. Each camera in a stereo camera has a field of view (FOV), and the fields of view the two cameras can be combined to give an overall field of view for the stereo camera. In a stereo camera, the fields of view tend to overlap.

The “stereo” nature of a stereo sensor allows for the determination of range information. It can also enable imaging in 3 dimensions, rather than only two dimensions.

Stereo cameras are well known, and have been used in many applications. As examples, stereo cameras have been found to have particular utility in providing three-dimensional (3D) imaging for mapping environments and navigating through them. In such uses, it is not uncommon to use multiple stereo cameras to increase the overall field of view of a system that uses such stereo cameras as an input.

For example, U.S. Pat. No. 7,446,766 demonstrates a use of stereo cameras for building evidence grids representing a physical environment and navigating through the environment.

### SUMMARY

In accordance with one aspect of the present disclosure, provided is a multi-camera head, comprising a head frame, a plurality of stereo cameras mounted to the head frame and arranged around an axis, and at least one stereo camera mounted to a top of the head frame, and across the axis.

In various embodiments, the plurality of stereo cameras can be pitched toward the axis at a pitch angle relative to vertical.

In various embodiments, the pitch angle can be in a range of between about 5° to about 15° relative to the vertical axis.

In various embodiments, the pitch angle can be in a range of about 10° to about 12° relative to the vertical axis.

In various embodiments, the pitch angle can be about 11.25° relative to the vertical axis.

In various embodiments, at least one of the plurality of stereo cameras includes two lenses in a plane, where the two lenses are offset at an angle relative to a horizontal axis of the plane.

In various embodiments, the offset angle can be about 45°.

In various embodiments, each of the plurality of stereo cameras can include two lenses in a respective plane, where the two lenses in each respective plane are offset at an angle of about 45° relative to a horizontal axis of the plane.

In various embodiments, the plurality of stereo cameras can be four stereo cameras.

In various embodiments, the multi-camera head can further comprise a body disposed between at least two stereo cameras from the plurality of stereo cameras.

In accordance with another aspect of the invention, provided is a multi-camera head, comprising four stereo cameras mounted to four respective sides of a head frame and arranged around a vertical axis, an elongated body disposed between a first pair of adjacent sides and a second pair of adjacent sides.

In various embodiments, the multi-camera head can further comprise at least one stereo camera mounted between the four stereo cameras, and across the vertical axis.

In various embodiments, the four stereo cameras can be pitched at a pitch angle toward the vertical axis.

In various embodiments, the pitch angle can be about 11.25° relative to the vertical axis.

In various embodiments, the camera lenses of at least one stereo camera can be offset at an offset angle relative to a horizontal axis.

In various embodiments, the offset angle can be about 45°.

In various embodiments, the multi-camera head can be coupled to a robotic vehicle.

In various embodiments, the multi-camera head can further comprise at least one light stack configured to generate outputs indicating a predetermined condition or state.

In accordance with another aspect of the invention, provided is a computer-implemented method of analyzing a pitch angle of a plurality of stereo cameras disposed around an axis in a multi-camera head. The method comprises modeling the multi-camera head as a point source at the center of a computer generated sphere, including defining a field of view of each stereo camera, entering a pitch angle for each stereo camera, graphically modeling the sphere, and graphically projecting a field of view of each stereo camera onto the sphere.

In various embodiments, the multi-camera can include a top stereo camera disposed between the plurality of stereo cameras disposed around the axis and the method can further comprise graphically projecting a field of view of the top stereo camera onto the sphere.

In various embodiments, the method can further comprise, in response to a user input altering a pitch angle of at least one stereo camera, graphically re-projecting the field of view of each stereo camera onto the sphere to display the altered pitch angle.

In accordance with aspects of the present invention, provided is a multi-camera head as shown in the drawings and described herein.

In accordance with aspects of the present invention, provided is robotic vehicle having a multi-camera head as shown in the drawings and described herein.

In various embodiments, the robotic vehicle can be autonomous or unmanned vehicle, e.g., a pallet truck or tugger.

In accordance with aspects of the present invention, provided is a computer-implemented method of analyzing a pitch angle of a plurality of stereo cameras disposed around an axis in a multi-camera head as shown in the drawings and described herein.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1 provides a perspective view of an embodiment of a multi-camera head, in accordance with aspects of the present invention;

FIG. 2 shows a top view of multi-camera head of FIG. 1, in accordance with aspects of the present invention;

FIG. 3 shows a front view of either of sides B or D of multi-camera head from FIG. 1, in accordance with aspects of the present invention;

FIG. 4 shows a front view of either of sides A or C of multi-camera head from FIG. 1, in accordance with aspects of the present invention;

FIG. 5 is a cross-sectional view of the multi- camera head cut along line A-A in FIG. 4, in accordance with aspects of the present invention;

FIG. 6 provides four different spherical projections of coverage areas of a multi-camera head, in accordance with aspects of the present invention, in accordance with aspects of the present invention;

FIGS. 7-11 provide different views of another embodiment of a multi-camera head in accordance with aspects of the present invention, in accordance with aspects of the present invention;

FIG. 12 is a flowchart depicting a computer-implemented method for analyzing pitch angle with a multi-camera head, in accordance with aspects of the present invention, in accordance with aspects of the present invention; and

FIG. 13 is an embodiment of a computer apparatus configured to drive and control a multi-camera head, in accordance with aspects of the present invention.

### DETAILED DESCRIPTION OF PREFERRED EMBODIMENTS

Hereinafter, aspects of the present invention will be described by explaining illustrative embodiments in accordance therewith, with reference to the attached drawings. While describing these embodiments, detailed descriptions of well-known items, functions, or configurations are typically omitted for conciseness.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

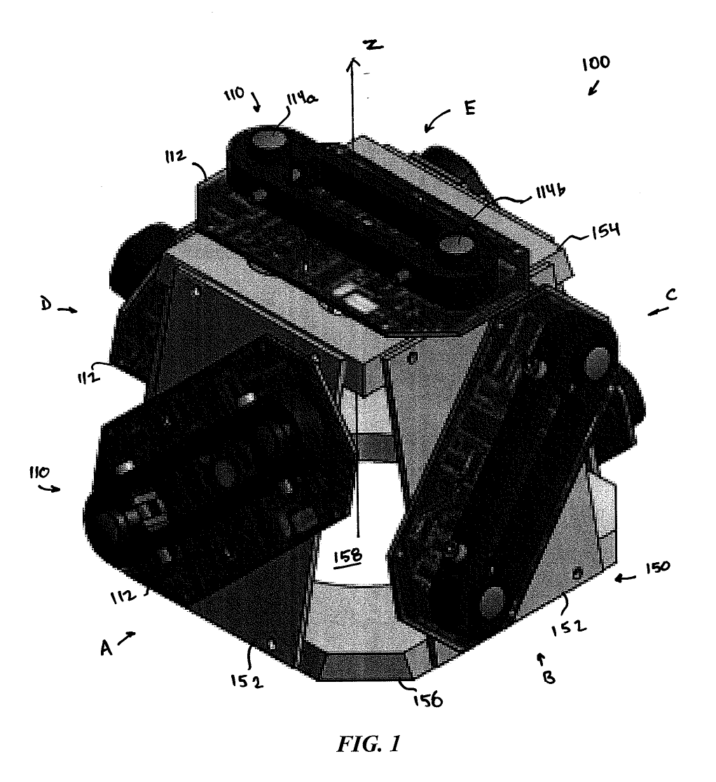

FIG. 1 provides a perspective view of an embodiment of a multi-camera head 100 in accordance with aspects of the present invention. Preferably, each camera is a digital stereo camera, each having a different field of view. In this embodiment, there are five stereo cameras.

A “stereo camera” is a type of camera with at least two lenses with a separate image sensor for each lens that are cooperatively processed to form a stereo image. This allows the ability to capture three-dimensional images, make stereo views and 3D images, and perform range imaging. The distance between the lenses in a typical stereo camera (the intra-axial distance) is about the distance between one's eyes (known as the intra-ocular distance) and is about 6.35 cm, although stereo cameras can have other intra-axial distances.

In this embodiment, multi-camera head 100 includes five stereo cameras 110 mounted on different sides of a head frame 150, e.g., sides A through E in FIG. 1. Sides A through D are generally arranged around an axis Z, with side E arranged on top of sides A through D and across, e.g., centered on, the axis Z. Sides A though D may be pitched inwardly toward the axis Z, which may be a central axis with respect to sides A through D.

There is no desire to image the ground in the present embodiment, since that is not particularly useful in the exemplary mapping and navigation context (e.g., for robotic vehicles). Therefore, there is no camera downwardly projecting at the bottom of the head frame. In other embodiments, however, there could be a desire for such a downwardly projecting camera. In this embodiment, each stereo camera 110 lens 114a, 114b is a DSL series lens, by Sunex, and has a field of view of about 90 degrees or more. As will be appreciated by those skilled in the art, the present invention is not limited to these specific stereo cameras.

Each stereo camera 110 includes a printed circuit board (PCB) 112, to which two camera lenses 114a and 114b are mounted. The PCB includes electronics that process image information received from lenses 114a, 114b into digital image information that is output to an apparatus connected to the stereo camera 110, such as a robotic vehicle, e.g., robotic warehouse vehicle. Such stereo image processing logic is known in the art, so is not described in detail herein. The stereo cameras 110 are mounted to head frame 150 by screws securing the PCBs 112 to respective frame sides A through E, in this embodiment.

The head frame 150 is made of a rigid material in this embodiment, such as a metal, fiberglass, or molded plastic. Each of the five sides A through E includes a mounting surface to which a respective stereo camera 110 can be mounted. In this embodiment, the mounting surfaces of sides A through D take the form of mounting plates 152. Mounting plates 152 (and sides A through D) are generally vertically disposed in this embodiment. And mounting surface E takes the form of a top frame member or plate 154 that is generally horizontally disposed. A bottom frame member or plate 156 is also provided in this embodiment, which is opposite and substantially parallel to the top frame member 154.

The bottom frame member 156, in this embodiment, defines an opening 158 (partially visible) that accommodates the passage of communication wires or cables, a mast of a robotic vehicle that uses the multi-camera head for data gathering and/or navigation, or a combination thereof. In this embodiment, therefore, it is presumed that a mast will be generally centrally disposed within head frame 150. However, the invention is not so limited. In other embodiments a mast or other support (e.g., a surface of a vehicle, equipment, or other structure) could be mounted at any one or more locations on the head frame, preferably not occluding the view of the cameras.

In this embodiment, a top of each mounting plate 152 is secured to top frame member 154 by screws and a bottom of each mounting plate 152 is secured to bottom frame member 156 by other screws. The resulting structure forms the substantially rigid head frame 150. In other embodiments, as an example, the entire head frame 150 could be a single, cast piece.

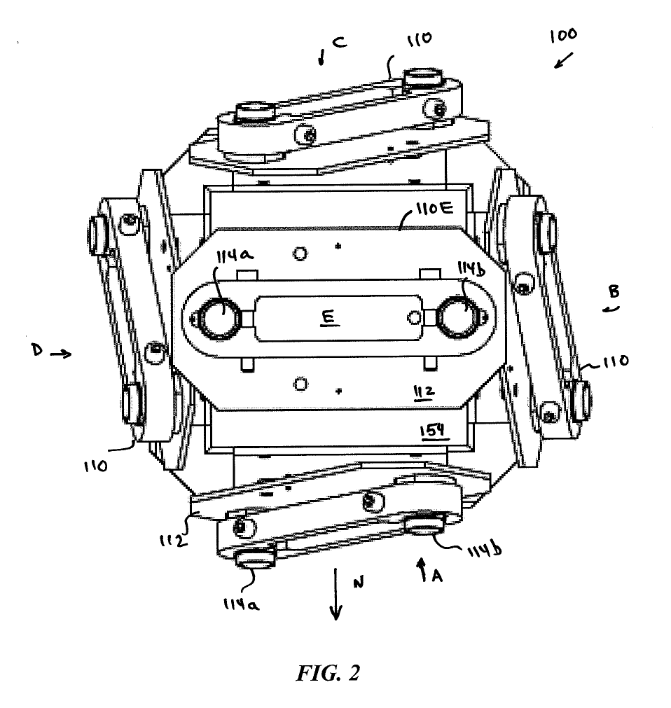

FIG. 2 shows a top view of multi-camera head 100 from FIG. 1. Here, mounting top frame member 154 and a top stereo camera 110E are clearly seen. For this embodiment, it is generally considered that the stereo camera 110E will be oriented substantially perpendicular to a direction of arrow “N,” which represents a general direction of movement of the multi-camera head in a mobile usage context (e.g., mapping, navigation, etc). However, the orientation of top stereo camera 110E with respect to a direction of movement is not limited to that shown. For example, in other embodiments, the orientation of top stereo camera can be at an angle relative to the direction of movement. Such orientation can be chosen based on the intended use of the multi-camera head 100.

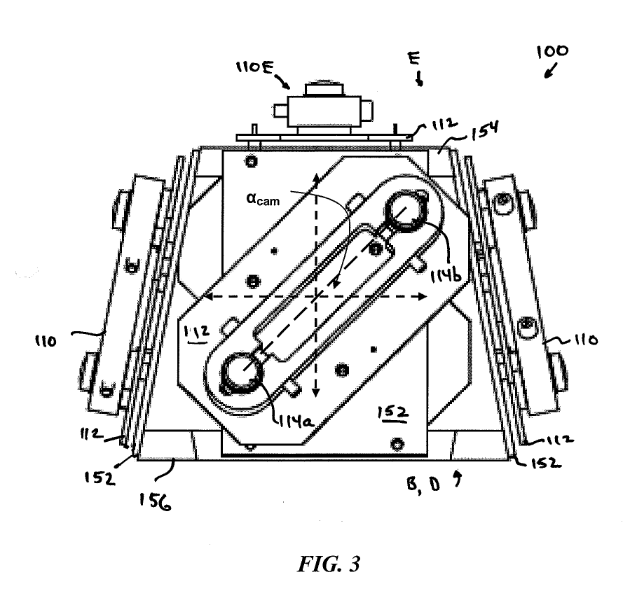

FIG. 3 shows a front view of either of sides B or D of multi-camera head 100 from FIG. 1. In various embodiments, on respective sides A through D, the stereo camera 110 is angularly offset or rotated—rather than being strictly vertically or horizontally oriented. In this embodiment, each stereo camera 110 is rotated or offset by about 45 degrees relative to a horizontal axis within a plane of the pair of lenses for a given side, the horizontal axis also being substantially parallel with a ground surface above which the multi-camera head is translated. An advantage of this angular offset of the lenses 114a and 114b is better detection of the horizon. In fact, if the lenses 114a and 114b were parallel to the horizon, they may not detect the horizon at all. Therefore, preferably, the offset angle (α_{cam},) of a pair of cameras relative to a horizontal axis in the lens plane is preferably between 0 and 180 degrees (i.e., 0<α_{cam}<180), in this embodiment. However, it should also be appreciated that for some uses no offset angle may be preferable. In the present embodiment, the offset angle a_{cam} is preferably 45 degrees.

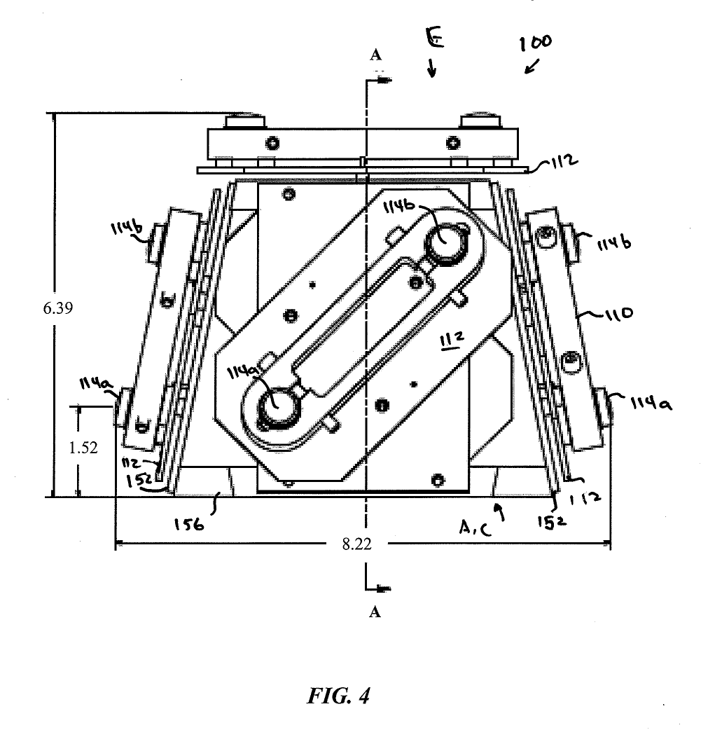

FIG. 4 shows a front view of either of sides A or C of multi-camera head 100 from FIG. 1. In this embodiment, relative to a bottom of bottom frame member 156, the multi-camera head has a height of about 6.39 inches to the surface of the lenses of the top stereo camera 110E of side E, a lens-to-lens distance of cameras 114a on opposite sides of about 8.22 inches, where the first lens 114a has a height of about 1.52 inches from the bottom of bottom frame member 156. The second lens 114b has a height from the bottom of bottom frame member 156 of about 3 inches, in this embodiment. Stereo cameras 114a and 114b have an intra-axial distance of about 4 inches in this embodiment. As will be appreciated by those skilled in the art, these dimensions could be different in other embodiments.

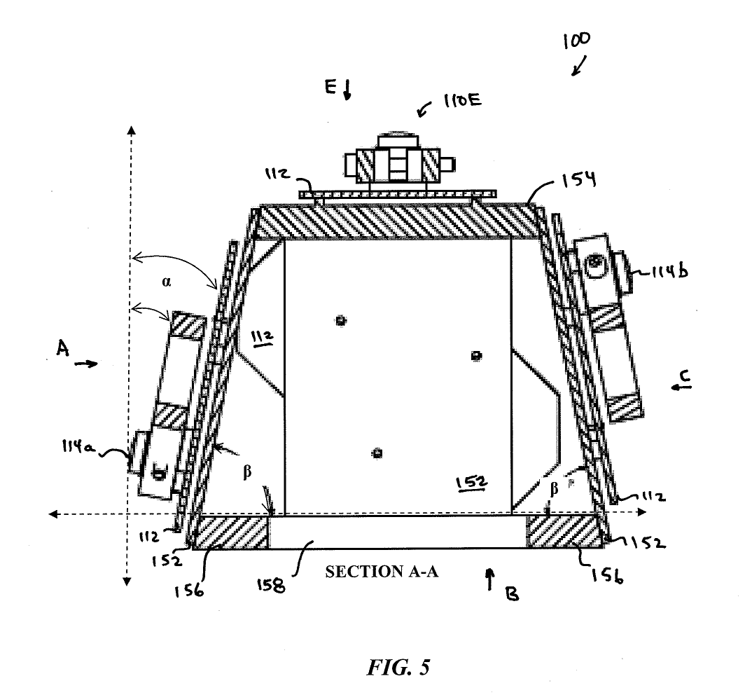

FIG. 5 is a cross-sectional view of the multi- camera head 100 cut along line A-A in FIG. 4. Mounting plates 152 are shown in cutaway form for sides A and C. A rear (or internal) view of mounting plate 152 for side D is visible. Top frame member 154 and bottom frame member 156 are also visible in cutaway form. From this view, opening 158 formed or defined in the bottom frame member 156 is apparent, as discussed above. Cross section of the stereo cameras 110 (including top stereo camera 110E) are also shown.

As is also visible from FIG. 3, the lenses 114a and 114b lie in a plane that is pitched toward a center of multi-camera head 100, referred to as pitch angle. The pitch angle with respect to a horizontal access is referred to herein as β. The pitch angle with respect to a vertical access is referred to herein as α. In this embodiment, all of the side cameras are pitched at the same angle, but this need not be the case in other embodiments, where different cameras can have different pitch angles, or less than all the side cameras can be pitched.

In this embodiment, a pitch angle of the mounting plate 152 is the same as the pitch angle of the camera lenses, because lenses 114a and 114b lie in a plane that is parallel to the associated mounting plate 152 in this embodiment. Therefore, the pitch angle of the mounting plate is transferred to the lenses, in the embodiment of FIG. 5. This pitch angle gives multi-camera head 100 a generally trapezoidal shape, in this embodiment. This shape is not required for the present invention. In fact, the cameras can be similarly pitched even if the head frame 150 does not have the exemplary trapezoidal shape. In various embodiments, β can be in a range of about 70 to 85 degrees from horizontal, but other pitch angles can be chosen in other embodiments. In this embodiment, the pitch angle β is preferably about 78.75 degrees from horizontal (or a is preferably 11.25 degrees from vertical).

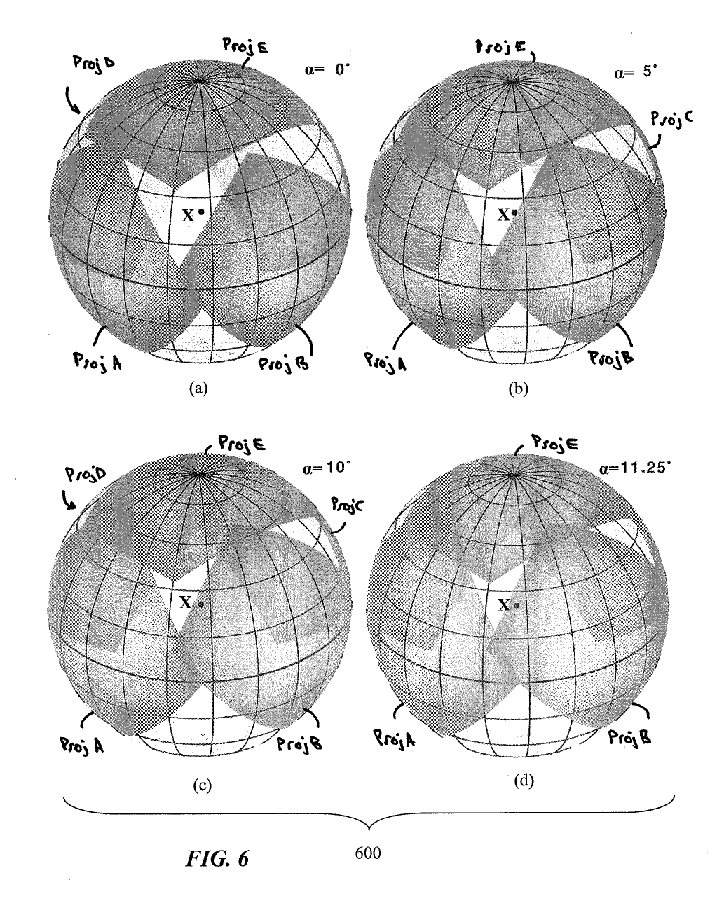

FIG. 6 provides five different field of view (FOV) projection patterns on a sphere, (a) through (d) (collectively 600), of a multi-camera head, assuming the projections originate at the sphere's center “X” and there is no downwardly projecting camera, in this embodiment. The pitch angle a (i.e., and (3) of four side cameras 110 of the multi-camera head 100 is different for each projection pattern (a) through (d). An angle or orientation of top camera 110E is unchanged across the four different projection patterns (a) through (d) and is horizontal in this embodiment.

In projection patterns (a) through (d), stereo cameras 110 discussed above were used. In projection pattern (a) α=0° with respect to vertical, i.e., β=90° with respect to horizontal (or ground surface). In projection pattern (b) α=5° with respect to vertical, i.e., β=85° with respect to horizontal. In projection pattern (c) α=10° with respect to vertical, i.e., β=80° with respect to horizontal. And in projection pattern (d) α=11.25° with respect to vertical, i.e., β=78.75° with respect to horizontal, as in the embodiment of FIG. 5.

In each of projection patterns (a) through (d), the top camera 110E is as described above. Accordingly, the projection from top camera 110E appears on top of the sphere, and is denoted as Proj_{E}. Projection patterns from the four side stereo cameras 110, one on each of sides A through D, are denoted as Proj_{A}, Proj_{B}, Proj_{C}, and Proj_{D}, respectively.

As can be seen, changing pitch angle a, 13 changes the FOV coverage collectively formed by projection patterns Proj_{A}, Proj_{B}, Proj_{c}, and Proj_{D}, and the overall FOV coverage when also considering projection Proj_{E}. The determination of a preferred pitch angle α, β can be a function of many considerations and how the multi-camera head 100 is to be used. In the present embodiment, given the exemplary stereo cameras, head frame, camera orientations on the frame, and context of 3-D mapping and navigation, the considerations include minimizing distortion, minimizing the number of cameras, and maximizing useful views. Given that, in this embodiment projection pattern (d), with a pitch angle of α=11.25° with respect to vertical β=78.75° with respect to horizontal is presently preferred. As will be appreciated by those skilled in the art, a different pitch angle, or no pitch angle (projection pattern (a)), could be preferred in other embodiments.

In FIGS. 1-5, the multi-camera head 100 is shown without a cover, which could be included. For example, a cover could be provided that substantially encases the multi-camera head, but also provides or defines openings or windows for the lenses 114a, 114b of the stereo cameras 110 (and 110E).

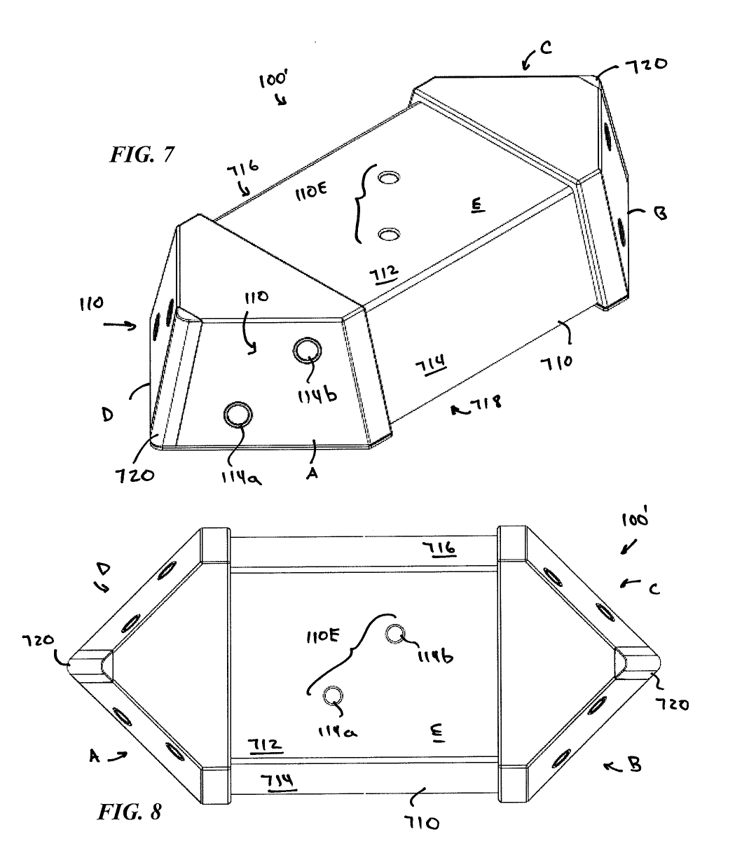

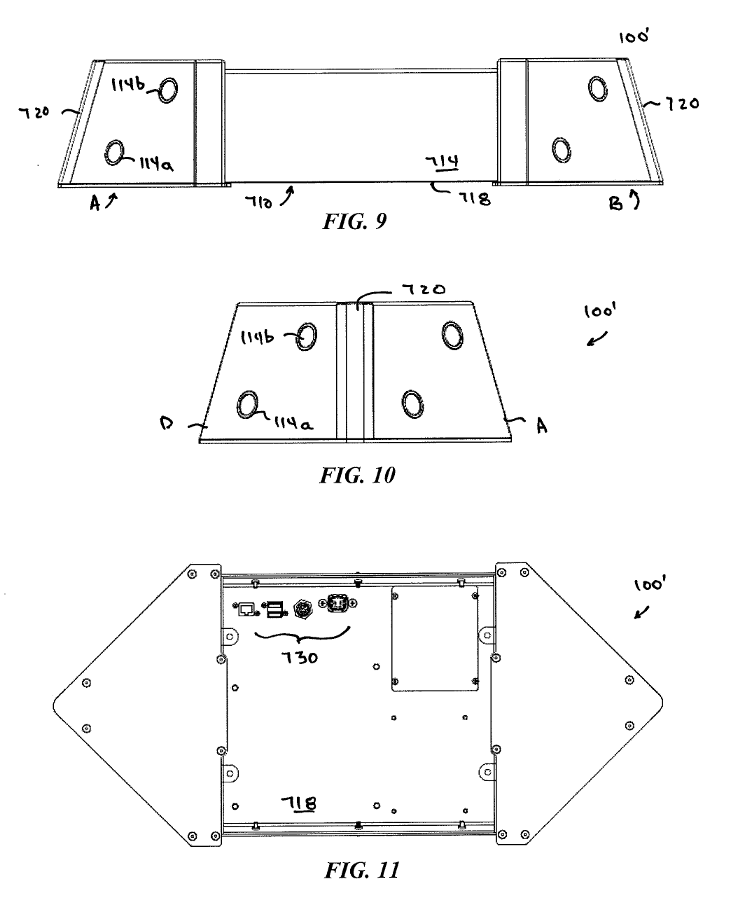

FIGS. 7-11 provide different views of another embodiment of a multi-camera head, in accordance with aspects of the present invention. FIG. 7 is a perspective view of a multi-camera head 100′, showing two wedge-shaped camera heads separated by an intermediate body 710, in accordance with aspects of the present invention. FIG. 8 is a top view of the multi-camera head 100′ of FIG. 7, showing a stereo camera 110E, i.e., a pair of lenses, on a top surface of the intermediate body 710, in accordance with aspects of the present invention. FIG. 9 is a side view of the multi-camera head 100′ of FIG. 7, showing one stereo camera 110 on an upright surface of each wedge-shaped head, in accordance with aspects of the present invention. FIG. 10 is a front view of the multi-camera head 100′ of FIG. 7, showing a stereo camera 110 on each of two upright surfaces of a wedge-shaped head, in accordance with aspects of the present invention. And FIG. 11 is a bottom view of the multi-camera head 100′ of FIG. 7, in accordance with aspects of the present invention.

In this embodiment, a multi-camera head 100′ is provided that includes a body 710 between sides. In this embodiment, sides A and D remain substantially adjacent to each other and sides B and C remain substantially adjacent to each other, with body 710 disposed in between. Side E is disposed within a top surface 712 of the body 710, between sides A and D and sides B and C. The body 710 can also include first and second sides 714, 716 and a bottom 718 (see FIG. 11).

The arrangement and orientation of the stereo cameras 110 can be substantially the same as that described above, as can the pitch angle α (or β) of the lenses 114a, 114b. The axial displacement and heights of the lenses 114a, 114b can also be the same as discussed above.

In various embodiments, a light stack 720 can be provided between sides A and D and/or sides B and C. The light stack can include one or more lights that can be used as external indicators of certain conditions of the multi-camera head 100′ or a system with which the multi-camera head 100′ communicates. In the case where the multi-camera head is coupled to a manned or unmanned vehicle or other piece of mobile equipment, the light stack could include light signals indicating vehicle or equipment statuses or warnings, as examples. Audio outputs can alternatively or additionally be added to the light stack 720, body 710, or otherwise to multi-camera head 100′ (or multi-camera head 100).

FIG. 11 shows that the bottom 718 of the body 710 including a set of ports or connectors 730 enabling quick connections to an external system, e.g., such as a robotic vehicle.

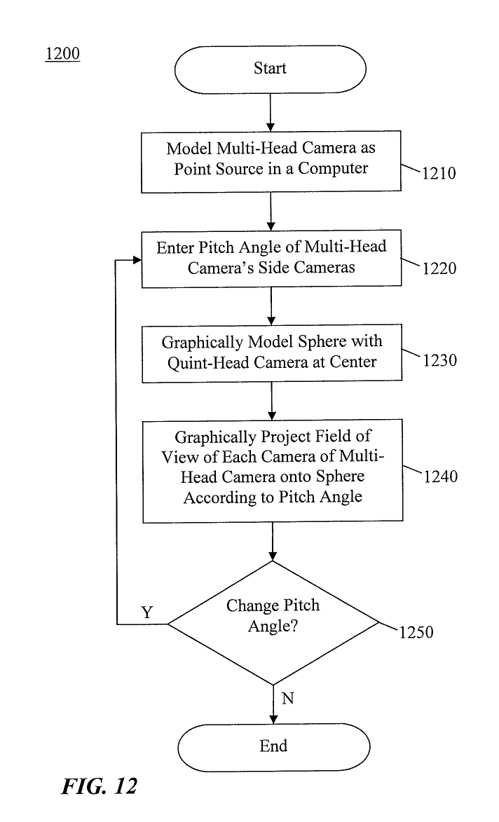

FIG. 12 is a flowchart depicting a computer-implemented method 700 for analyzing pitch angle with a multi-camera head, in accordance with aspects of the present invention. In step 1210, a multi-camera head, such as multi-camera head 100 and 100′ above, is modeled as a point source in a computer. As a point source, a multi-camera head having five stereo cameras can be considered to be five collocated point sources that project in different directions according to the intended arrangement of the cameras in the physical world. FOVs of a stereo camera are known in advance. The physical relationships of the five stereo cameras are also known in advance, e.g., as implemented in the head frame. In FIG. 6, for example, it is assumed that the four side cameras 110 have FOVs in the same horizontal plane, projecting perpendicularly within the plane from the origin in the respective direction of the positive and negative X axis and Y axis, with top camera 110E having a FOV in the direction of the positive Z axis.

In step 1220, a pitch angle of the four side cameras is entered, or defined within the computer. In step 1230, a sphere is modeled by the computer, with the multi-camera head at its center. In step 1240, the FOVs of the cameras of the multi-camera head are projected from the center onto the sphere, which can be graphically shown on a computer screen. Projection patterns (a) through (d) in FIG. 6 are examples of such graphical representations. In step 1250, there is an option to change the pitch angle, which returns the method to step 1220 for another cycle of processing.

In some embodiments, the compute could enable graphical interaction with the sphere and/or FOV projections. For example, a user could be allowed to “grab” a FOV projection and move it, and the computer could adjust the other FOV projections and output the resultant pitch angle. In another embodiment, the computer could be enabled to maximize FOV coverage for the entire sphere or a designated portion thereof. In yet another embodiment, different cameras could be defined within the computer, and the computer could comparatively show FOV projections of the different cameras on the same sphere—or recommend cameras or camera combinations for best achieving a defined set of requirements, e.g., maximize FOV coverage for the sphere or a designate portion of the sphere.

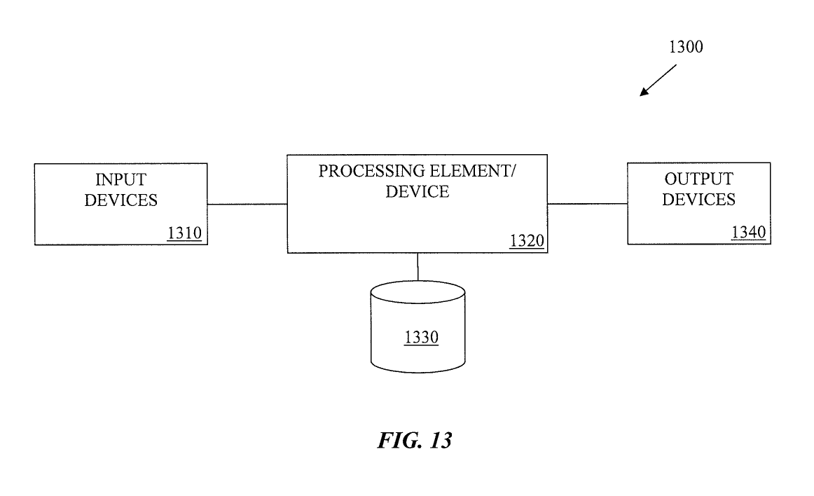

FIG. 13 is an embodiment of a computer system 1300 that could be used to implement the method of FIG. 12. The computer system 1300 can include one or more of a personal computer, workstation, mainframe computer, personal digital assistant, cellular telephone, computerized tablet, or the like.

One or more input devices 1310 is included to provide data, information, and/or instructions to one or more processing element or device 1320. Input device 1310 can be or include one or more of a keyboard, mouse, touch screen, keypad or microphone, as examples.

The processing element/device 1320 can be or include a computer processor or microprocessor, as examples. Processing element or device 1320 can retrieve, receive, and/or store data and information, e.g., in electronic form, from a computer storage system 1230.

Computer storage system 1330 can be or include one or more non-transitory storage media or system for computer data, information, and instructions, such as electronic memory, optical memory, magnetic memory, and the like. A computer storage media can, for example, be volatile and non-volatile memory and take the form of a drive, disk, chip, and various forms thereof, and can include read only memory (ROM) and random access memory (RAM).

The processing element/ device 1320 can output data and information to one or more output devices 840. Such output devices can include any of a variety of computer screens and displays, speakers, communications ports or interfaces, a network, or separate system, as examples. In cases of touch screens, input devices 810 and output devices 840 can be merged in a single device.

In one embodiment, output devices 1340 include a computer display that renders screens including spherical projections like those shown in FIG. 6, or related graphical input and output mechanisms.

While the foregoing has described what are considered to be the best mode and/or other preferred embodiments, it is understood that various modifications can be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

What is claimed is:

1. A multi-camera head, comprising:
a head frame;
a plurality of stereo cameras mounted to the head frame and arranged around an axis; and
at least one stereo camera mounted to a top of the head frame, and across the axis.

2. The multi-camera head of claim 1, wherein the plurality of stereo cameras are pitched toward the axis at a pitch angle relative to vertical.

3. The multi-camera head of claim 2, wherein the pitch angle is in a range of between about 5° to about 15° relative to the vertical axis.

4. The multi-camera head of claim 2, wherein the pitch angle is in a range of about 10° to about 12° relative to the vertical axis.

5. The multi-camera head of claim 2, wherein the pitch angle is about 11.25° relative to the vertical axis.

6. The multi-camera head of claim 1, wherein at least one of the stereo cameras includes two lenses in a plane, where the two lenses are offset at an angle relative to a horizontal axis of the plane.

7. The multi-camera head of claim 6, wherein the offset angle is about 45°.

8. The multi-camera head of claim 1, wherein each of the plurality of stereo cameras includes two lenses in a respective plane, where the two lenses in each respective plane are offset at an angle of about 45° relative to a horizontal axis of the plane.

9. The multi-camera head of claim 1, wherein the plurality of stereo cameras is four stereo cameras.

10. The multi-camera head of claim 1, further comprising:
a body disposed between at least two stereo cameras from the plurality of stereo cameras.

11. A multi-camera head, comprising:
four stereo cameras mounted to four respective sides of a head frame and arranged around a vertical axis; and
an elongated body disposed between a first pair of adjacent sides of the head frame and a second pair of adjacent sides of the head frame, each side of the head frame comprising a stereo camera from the four stereo cameras.

12. The multi-camera head of claim 11, further comprising:
at least one stereo camera mounted between the four stereo cameras, and across the vertical axis.

13. The multi-camera head of claim 11, wherein the four stereo cameras are pitched at a pitch angle toward the vertical axis.

14. The multi-camera head of claim 13, wherein the pitch angle is about 11.25° relative to the vertical axis.

15. The multi-camera head of claim 11, wherein camera lenses in at least one stereo camera are offset at an offset angle relative to a horizontal axis.

16. The multi-camera head of claim 15, wherein the offset angle is about 45°.

17. The multi-camera head of claim 11, wherein the multi-camera head is coupled to a robotic vehicle.

18. The multi-camera head of claim 11, further comprising:
at least one light stack configured to generate outputs indicating a predetermined condition or state.

19. A computer-implemented method of analyzing a pitch angle of a plurality of stereo cameras disposed around an axis in a multi-camera head, the method comprising:
modeling the multi-camera head as a point source at a center of a computer generated sphere, including defining a field of view of each stereo camera;
entering a pitch angle for each stereo camera;
graphically modeling the sphere; and
graphically projecting a field of view of each stereo camera onto the sphere.

20. The method of claim 19, wherein the multi-camera includes a top stereo camera disposed across the plurality of stereo cameras disposed around the axis and the method further comprising:
graphically projecting a field of view of the top stereo camera onto the sphere.

21. The method of claim 19, further comprising:
in response to a user input altering a pitch angle of at least one stereo camera, graphically re-projecting the field of view of each stereo camera onto the sphere to display the altered pitch angle.
